(19) United States
(12) Patent Application Publication
(10) Pub. No.: US 2007/0149114 A1
(43) Pub. Date: Jun. 28, 2007

(54) Capture, storage and retrieval of broadcast information while on-the-go

(76) Inventor: Andrey Danilenko, Santa Monica, CA (US)

Correspondence Address: CARR & ASSOCIATES, 9TH FLOOR, 9595 WILSHIRE BLVD., BEVERLY HILLS, CA, 90212, US

(21) Appl. No.: 11/319,899

(22) Filed: Dec. 28, 2005

(51) Int. Cl. H04H 7/00

(52) U.S. Cl. 455/3.06

(57) ABSTRACT

A system and method for allowing a listener to selectively capture and record information encoded within a radio or television broadcast signal and later use said information in order to obtain product/retail information related to the broadcast. The system and method comprising a remote server having a memory/database for storing programming information from a radio broadcast of a member station, a data capture device for allowing a user to selectively capture and record inaudible information encoded within said radio broadcast, and software for allowing the data capture device and the remote server to actively communicate via the Internet such that the selectively captured and recorded inaudible information can be used to access and retrieve relevant programming information stored at the remote server and enable immediate purchase or further research of items described by that programming information.

### FIELD OF THE INVENTION

The invention relates to the transmission and capture of encoded information over a broadcast signal. More specifically, the invention relates to system which uses a portable receiver to selectively capture and store information encoded within a broadcast signal, said portable receiver generating a time stamp for said information as it is captured such that the information can then be used, at a later time, in order to retrieve further information about the broadcast, including purchase information for various songs/artists which were included within the broadcast.

### BACKGROUND OF THE INVENTION

In modern day, we are constantly bombarded with information designed to enrich and enhance our lives. One aspect of this information is derived from radio broadcasts which we may be exposed to at various times over the course of any given day—i.e. while driving in our automobiles to and from work or while listening to the radio at the office. More particularly, we are inundated with music/songs, commercial advertisements, news, weather, public service announcements and other material information over very short periods of time as we listen to radio broadcasts throughout our day.

Many times, a user may be exposed to a particular song, a product advertisement, or a public service announcement in which he or she has an interest. Unfortunately, the user may catch only a portion of the broadcast and may be unable to identify the specific content to which he or she has just been exposed. More specifically, a user might hear a particular song he or she enjoys, or portion thereof, but be unaware of the title or artist of such a song.

Currently, there exists technology that allows broadcast information to be identified as it is received and reproduced for listening/playing aloud over a set of speakers. More specifically, there exists numerous methods for encoding/embedding inaudible identifying information into a radio broadcast signal at the transmit side and for then extracting this encoded/embedded inaudible information at the receiver end as the broadcast is playing. For example, modern radio receivers in most recent automobiles include advanced receivers for receiving and recognizing any digital information encoded/embedded into a radio broadcast, such as a station identifier—e.g. the station name and/or call letters of the station, a song identifier which includes the title of the song, and even an artist identifier which identifies the particular artist performing the song. This information is typically received and displayed at the user end, in real time, as the broadcast is received. As the program content changes, the inaudible embedded information included within the broadcast signal also changes and the displayed information is updated accordingly.

One major limitation to this technology is that it is not helpful in assisting a user in later identifying the informational content he or she previously listened to at that moment in time. More specifically, unless the user has a piece of paper and a pen readily at hand with which to record/note the identifying information as it is received and reproduced, the information is lost as the program continues to play. In particular, if the user is on the go, it is doubtful he or she will have time to note the identifying information at the exact time it is displayed and unless such user has a photographic memory, it is doubtful he or she will later be able to recall the identifying information with a high degree of accuracy.

An additional limitation to this technology is that it is not present in older automobile radios or in most portable radios currently in use, such as older hand held radios or AM/FM alarm clock radios. Accordingly, unless a user is prepared to give up his or her current radio device for a costly and expensive upgrade, such technology is not obtainable.

What is needed is a system and device where users can keep their current automobile or current portable radio and still be able to exploit and use this technology with any conventional radio receiver. What is further needed is improvement to this technology which will allow a user to, at any point in time, selectively capture identifying information encoded/embedded within a radio broadcast signal and record such information for future use. Finally, what is further needed is a method and system which capitalizes on utilizing this information in order to automatically direct a user to resources pertinent to broadcast information, such as automatically directing a user to a web-site location where he or she can purchase music which he or she may have previously heard during an earlier radio broadcast or product he or she heard advertised.

### SUMMARY OF THE INVENTION

The present invention is for a system and method which allows a user at any point in time to selectively capture identifying information encoded/embedded within a radio broadcast signal and record such information for future use. The system and method then further capitalizes on utilizing this information in order to automatically direct a user to resources pertinent to the broadcast. Preferably, the system and method includes a portable data capture device that allows a user to conveniently and selectively capture and store identifying information embedded/encoded within a radio broadcast for future use. In the system of the present invention, member radio stations are assigned station identification numbers and each of their individual programming information is downloaded and stored at a remote server location. Using the data capture device and an Internet ready/capable device such as a PC or laptop, a user connects to the remote server location and the previously captured information, now stored within the data capture device, is used to retrieve the appropriate programming information, along with additional information relevant to the broadcast program.

Utilizing the present invention, a user can capture and record information which can then later be used, at a much more convenient time, to direct the user to various websites where additional information relevant to the programming information contained in the earlier broadcast can be found, including websites where users can purchase music which was heard in the earlier broadcast or product that was advertised in that broadcast and arose a user's interest.

### DESCRIPTION OF THE DRAWINGS

FIG. 1 illustrates a system wide configuration in which a preferred embodiment of the present invention is utilized;

FIG. 2a-b, illustrate graphical representations of two different broadcast program segments from two different stations STATION 1 and STATION 2;

FIG. 3 illustrates a preferred embodiment of the inner workings/components of the data capture device;

FIG. 4 illustrates a system in which the data capture device of the present invention is then used to retrieve additional information about or pertaining to the previously captured broadcast information, including hyperlinks designed to direct the user to sites where the song/album can be purchased;

FIG. 5 illustrates the concept of storing program information from various radio stations in accordance with a preferred embodiment of the present invention; and

FIG. 6, is a flow chart which illustrates the process for allowing a user to selectively capture inaudible information embedded in a broadcast signal and use that information in order to later identify broadcast information/content and obtain additional information, including information on where to purchase music heard during the broadcast.

### DETAILED DESCRIPTION OF PREFERRED EMBODIMENTS

The invention consists of a system and method, which allows a user to selectively capture and store information embedded/encoded within a transmitted broadcast and later use that information to access additional product/purchase information via the Internet. In a preferred embodiment, the system includes a portable (handheld or wearable) data capture device which may be selectively activated by a user at various times in order to capture information which is encoded/embedded and transmitted within a broadcast signal (such as information which may be embedded in a radio broadcast signal). The information is time stamped as it is captured and is then stored in a memory located within the data capture device. At a later time, the user may then sync the data capture device to a remote server, preferably via the Internet, in order to retrieve additional information, such as product/purchase information which is relevant and pertinent to the broadcast information earlier captured.

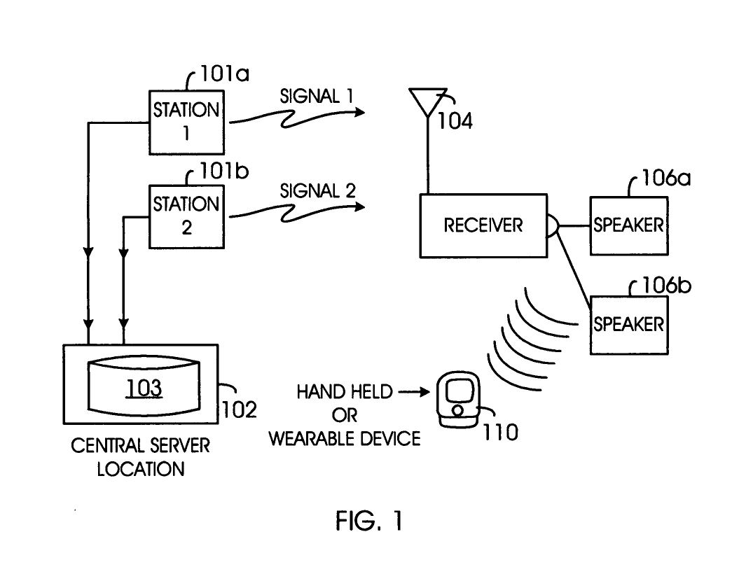

FIG. 1 illustrates a system wide configuration in which a preferred embodiment of the present invention is utilized. As shown, the system includes a number of radio broadcast stations 101a-b (STATION 1 and STATION 2) which each provide separate radio broadcast signals. As will be discussed in greater detail further hereinafter, each station which is included in the system in which the present invention is utilized is assigned a STATION ID NUMBER which is unique to that subscribing station. This STATION ID NUMBER is unique to each member station in the system such that no station in the system has the same number.

In accordance with the present invention, and as will be further explained hereinafter, each station provides its own individual broadcast signal comprised of its own desired programming content and information. The programs broadcast by each station are determined solely by the station managers and operation of the invention is not dependent upon the programmed broadcast content, except to say that each station is configured to include within its broadcast signals encoded/embedded messages designed to identify that station—i.e. each station is configured to encode and embed within its broadcast signal its STATION ID NUMBER. Preferably, these embedded/encoded messages are inaudible and do not effect the transmission of the audio signals over the airwaves. Additionally, the STATION ID NUMBER is preferably encoded and embedded within the broadcast signal at preset or predetermined time intervals of very short duration such that STATION ID NUMBER is preferably broadcast at least more than one time during any particular segment of the programming—i.e. at least more than one time during any particular song, commercial or public service announcement. There are several known techniques for embedding inaudible encoded messages into broadcast audio signals and the invention is designed to work with any one of these techniques. For example, U.S. Pat. No. 5,581,800 issued to Fardeau et al. teaches a technique for encoding identifying information into an audio signal. Similarly, U.S. Pat. No. 6,754,633 issued to Yin and U.S. Pat. No. 6,845,360 issued to Jensen et al. also teach techniques for embedding/encoding identifying information into an audio signal. It is understood that the invention is designed to work with any one of these or other techniques currently known in the art, as well as an obvious derivations thereof.

In a preferred embodiment, as the stations send out their broadcast signals, embedded and encoded within and transmitted with each of these signals is their individual STATION ID NUMBER. In a preferred embodiment, the STATION ID NUMBER is embedded and encoded within and broadcast out over the signal at very short, regular time intervals. For example, in a preferred embodiment, each station may be configured to encode/embed and transmit its STATION ID NUMBER at regular thirty second intervals of time, such that every thirty seconds the broadcast signal will further include inaudible information identifying the station from which the signal originates by its STATION ID NUMBER.

Referring still to FIG. 1, each station is also configured to provide the contents of their individual broadcast signals (i.e. their broadcast program information) to a central server location 102, where the program information is stored in a centralized memory 103. Preferably this is done via the Internet in real time as the programming is played at the individual stations. Alternatively, the stations may provide hourly or daily updates of their programming. As will be discussed later herein, the information is preferably stored/organized and/or arranged by STATION ID NUMBER.

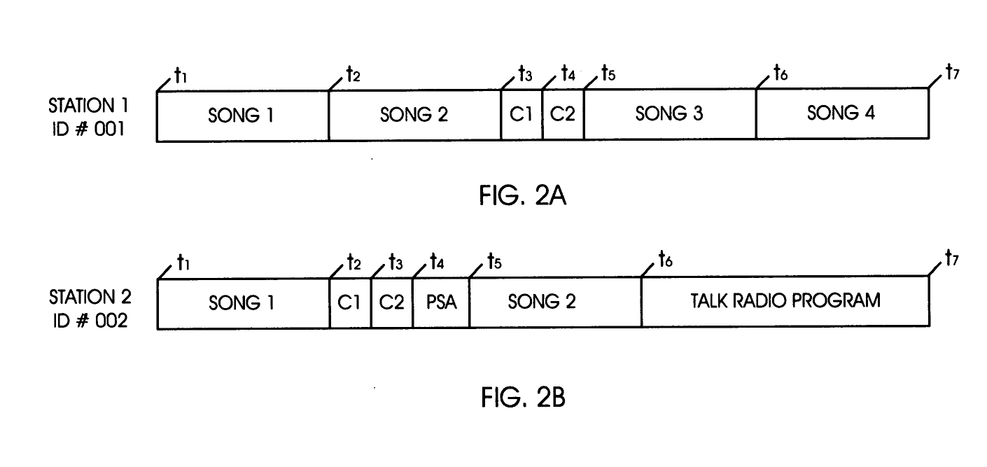

Referring now to FIG. 2a-b, there are shown graphical representations of two different broadcast program segments from two different stations STATION 1 and STATION 2. As shown, the segment in FIG. 2a is from STATION 1 which is assigned STATION ID NUMBER 001, while the programming segment shown in FIG. 2b is from STATION 2 which is assigned STATION ID NUMBER 002.

As shown in FIG. 2a, STATION 1 plays SONG 1 from time t1 until time t2, at which time SONG 2 begins playing. At time t3, SONG 2 ends and a commercial (labeled as C1) is played as part of the broadcast; followed by a second commercial (labeled as C2). Finally, following the second commercial, STATION 1 resumes programming by playing SONGS 3 and 4. Similarly, the segment shown in FIG. 2b is from STATION 2 and illustrates the programming content played by STATION 2 between times t1 and t7. As shown, STATION 2 plays SONG 1 from time t1 until time t2, following by two commercials (C1 and C2) and a public service announcement (PSA). Begin at time t6, STATION 2 programming includes a talk radio program.

It is important to note that the times t1 through t7 shown for each of the STATIONS do not necessarily correlate (e.g. the t3 shown in FIG. 2a is not the same time as the t3 shown in FIG. 2b); but, all times are measured from a constant time source. Accordingly, all members stations to the system measure start and stop times of various programming elements in their broadcast from a universal time clock and provide these start and stop times, along with information sufficient to identify the individual programming item (such as the song title or commercial sponsor), and information sufficient to identify that particular station (i.e. the STATION ID NUMBER) to the central server location 102, where such information is stored for future reference and use.

Referring again to FIG. 1, the broadcast signals from each station are received at antennae 104, which may be any conventional auto-radio antennae or the antennae of a portable radio/boombox, and the signals are then transmitted to receiver 105. Alternatively, the receiver 105 may be configured with a built in, wireless antennae such that the signals are received directly by receiver 105. The receiver is tuned to receive a broadcast from a selected station, as predetermined by the user's selection or setting, and the selected signal is then processed by receiver 105 and broadcast over speakers 106a, b as with any conventional broadcast signal receiver.

Further shown in FIG. 1 is portable data capture device 110. The device preferably includes a display and an activation button. The device 110 is configured to be small, lightweight and highly portable, and may even be worn by the user about his or her neck or waist, or in his or her pocket, or built into another portable device such as for example a cell phone, an MP3 player, a portable radio, a pen, or a key chain. In operation, when the audio signals broadcast over speakers 106a-b contain information, such as a particular song or advertisement for a commercial product or service, in which a user is interested, he or she presses activation button and the portable data capture device 110 generates a time stamp and begins capturing inaudible information embedded/encoded within the audio signals being broadcast over speakers 106a,b.

In a preferred embodiment, upon pressing a button the portable data capture device 110 is configured to capture data until the station ID is captured and recorded or for a set time interval from the time the activation is pressed—i.e. the data capture device will preferably record information encoded/embedded in the audio signals broadcast over speakers 106a,b for a set period of time such as one to three minutes. Alternatively, the portable data capture device may be configured to continually capture data embedded in the audio signals broadcast over speakers 106a,b until the activation button is depressed for a second time—i.e. the data capture device will begin capturing and storing information from the time the activation is first pressed until the button is again depressed by the user.

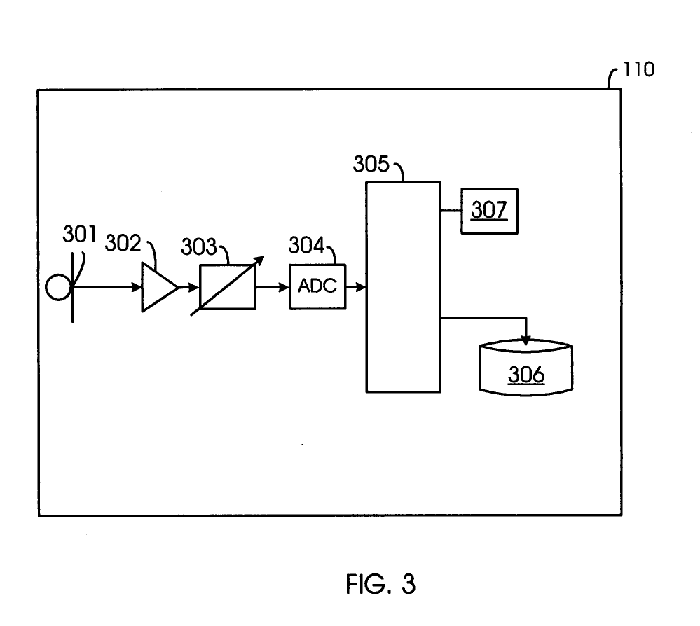

FIG. 3 illustrates a preferred embodiment of the inner workings/components of the data capture device 110. As shown, in FIG. 1, the data capture device is placed within the listening vicinity/area of a speaker or set of speakers. It selectively receives broadcast audio signals which are reproduced at speaker(s) 106a,b (when activated) and detects, captures and records inaudible encoded information contained or embedded within said broadcast audio signals. Referring to FIG. 3, the data capture device preferably includes a microphone 301, for receiving/picking-up the broadcast audio signals reproduced by the speaker(s). The microphone 301 is connected via amplifier 302 to a filter 303. In a preferred embodiment, filter 303 is designed to filter out all frequencies except the narrow frequency range containing the embedded/encoded messages—i.e. that portion of the signal containing the inaudible STATION ID NUMBER which has been encoded and embedded within the broadcast signal.

Referring still to FIG. 3, the output from filter 303 is connected via an analog to digital converter 304 to the input of a data processor 305. The data processor is further coupled to a memory device 306 (which may be a flash card memory, a small memory chip, or other suitable device) for storing the STATION ID NUMBER as it is captured. As further shown in FIG. 3, the data capture device will also include a built in clock 307, which is preferably synchronized with the constant time source with which all member stations are also tied when setting up their individual programming segments. This clock is used to generate a time stamp whenever the device is activated. As discussed in further detail hereinafter, the clock may be regularly calibrated and updated to ensure its accuracy.

As further shown in FIG. 3 the device is preferably equipped with an LED or similar display 309 which is coupled to the data processor 305 via a graphics interface/processor 308. In operation, when the capture device is activated the LED will illuminate. Furthermore, in a preferred embodiment, as information embedded in the broadcast signal being received is detected by the device, it is displayed on the LED. This information may include the STATION ID NUMBER, the call letters of the radio station, the title of the song, the name of the artist, and the time. Alternatively, and in a more simplistic model, no display is included in the capture device.

In operation, when the data capture device 110 is activated, a time stamp is generated by the clock and transmitted to data processor 305. Furthermore, when the data capture device is activated, the microphone 301 picks-up the broadcast audio signals as they are reproduced by the nearby speakers. Amplifier 202 then boosts the audio signals, while filter 203 filters out all frequencies except the narrow frequency range containing the encoded/embedded information—i.e. that part of the broadcast signal through which the STATION ID NUMBER has been transmitted. The filtered portion of the signal is then converted from analog to digital and data processor 205 is used to actually detect the STATION ID NUMBER encoded within the broadcast audio signal.

In a preferred embodiment, the data processor is used to detect STATION ID NUMBERS embedded/encoded within the received audio signal being reproduced by nearby speakers 106a,b. More specifically, the data processor receives the converted digital signal and detects the STATION ID NUMBER embedded in this signal (systems and methods of such decoding currently exist; see, for example, U.S. Pat. No. 6,871,180 B1). Once the

STATION ID NUMBER is detected, the STATION ID NUMBER and the time stamp are both stored within the memory device 306 for future reference and use, as will be described further hereinafter.

As described earlier herein, each station is preferably configured to embed its STATION ID NUMBER at regular, shortened time intervals into its broadcast signal—e.g. every 30 seconds. Accordingly, in a preferred embodiment, the maximum amount of time that should pass between activating the data capture device and detection/recordation of any STATION ID NUMBER and time stamp should be a maximum of 30 seconds and preferably even shorter in length.

Accordingly, over the course of a day, a week, or even a month, a user will at various times hear a song or other program item over the radio and he or she need only press a single button in order to have information relevant to that song/information (the STATION ID NUMBER and the time stamp) captured and recorded for future use. Using this information at a more convenient time the user can then access a centralized database, located at the remote server location where the individual programming for each of the member stations is stored, where specifics about the song and the artist, along with Internet hyperlinks designed to direct the user to sites where the song/album can be purchased, are permanently stored.

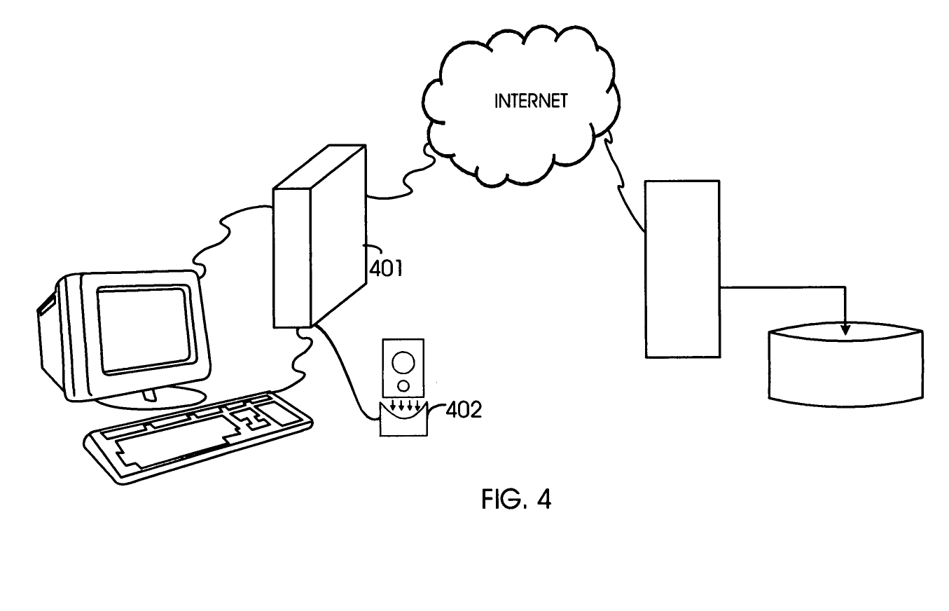

More specifically, referring now to FIG. 4 there is shown a system in which the data capture device 110 of the present invention is then used to retrieve additional information about or pertaining to the previously captured broadcast information, including hyperlinks designed to direct the user to sites where the song/album can be purchased. As shown, this system preferably includes a PC/laptop 401 or other computer enabled device which is connected/connectable to the Internet. The system further preferably includes a hot sync cradle 402 which is electrically coupled to the PC/laptop. The hot sync cradle may be coupled to the PC/laptop in a wired or wireless fashion. The hot sync cradle is designed to hold the data capture device 110. The system further includes software which is downloaded onto the PC/laptop and which allows the data capture device and the PC/laptop to communicate back and forth with the remote server location in a simple and seamless effort in order to provide additional information to the user which is relevant to the previously captured and recorded broadcast information.

In operation, a user will insert the data capture device 110 into the hot sync cradle. Once an insertion has been detected, the PC/laptop will then communicate with the hot sync cradle in order to extract the previously captured program information from the data capture device. More specifically, the hot sync cradle detects when a data capture device has been inserted into the cradle and the PC/laptop is then directed via the Internet to a remote server location where all of the participating station program information has been previously stored, as described earlier herein. The STATION ID NUMBER and the time stamp are retrieved from the data capture device and used to access information stored at the remote server location. In an alternative embodiment, no hot sync cradle is needed and the data capture device may itself be connected directly to a user's PC or laptop via a wired or wireless interface, such as a USB port. In this alternative embodiment, the data capture device must be configured with electronics sufficient to enable this type of communication.

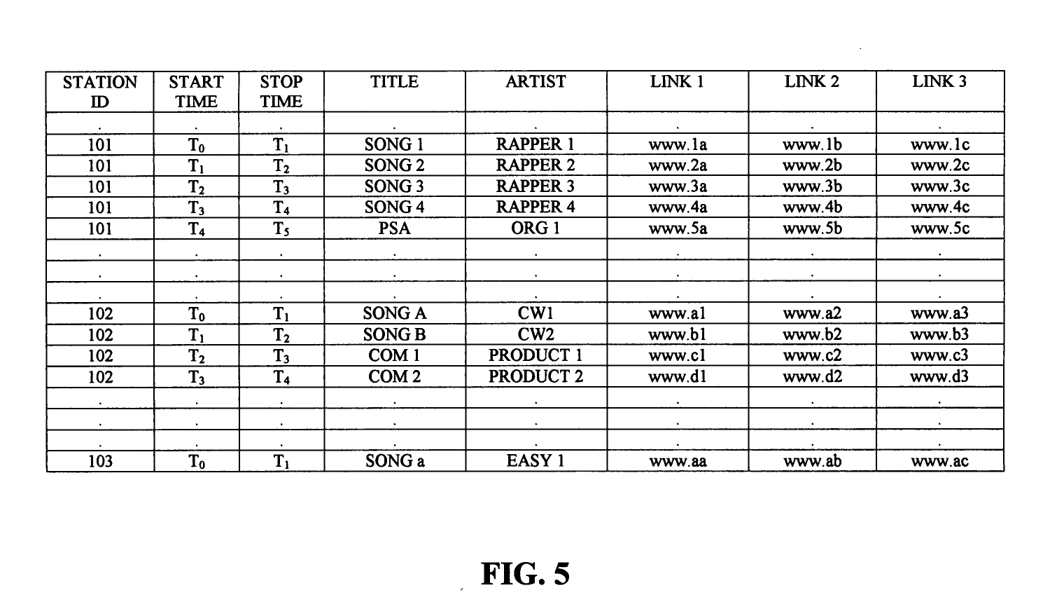

Referring to FIG. 5 there is shown a sample of information stored in a database/memory at a remote server location which is accessed by a user's PC/laptop or other Internet enabled device when the data capture device is placed into the hot sync cradle (or coupled to the user's PC/laptop or other Internet enabled device). As shown in FIG. 5, information in the memory/database at the remote server location is preferably arranged by STATION ID NUMBER. The information includes the start and stop time of each segment, the title of the segment (such as the title of the song, or the title of the commercial or public service announcement), the name of the artist performing the song (or in the case of a product advertisement or public service announcement the name of the sponsor/advertiser), and a number of web links where additional information about the song and/or artist can be found, including at least one website where the artist's album or song can be purchased.

Referring still to FIG. 5, one can see that STATION ID NUMBER 101 broadcast a song entitled SONG 1 performed by RAPPER 1 between time t0 and t1. As further shown, a series of web links are also stored along with this information. In practice, as programming information is downloaded to the remote server location, a computer program residing on that server may perform a search of the Internet for additional information about the song and/or artist and the results of this search are then stored with the programming information (including at least one website where the artist's album or song can be purchased).

As explained earlier, the data capture device is designed to capture and record STATION ID NUMBERS and time stamps when activated. In practice, when a user connects the data capture device to the Internet, either directly or via a cradle and PC/Laptop or other Internet enabled device, this information is extracted from the data capture device and a search of the programming information stored at the remote server location is initiated. First, the STATION ID NUMBER is matched in order to narrow the search. The start and stop times are then searched in order to ascertain where the actual time stamp which has been recorded within the data capture device falls, and that entry is then selected. Accordingly, if the STATION ID NUMBER recorded in the data capture device is STATION ID NUMBER 102 then the entries for that station are further searched. Assuming the corresponding time stamp is time t1a and that time falls between start time t1 and stop time t2, the search results in the selection of the entry for STATION ID NUMBER 102 with start time t1 and stop time t1, which corresponds with song title SONGB, performed by artist CW2. Accordingly, this information, along with the corresponding web links (www.b1, www.b2, and www.b3) will all be retrieved and transmitted back to the user's PC/laptop so that he or she may then jump directly to those websites in order to find out more information about the song and/or artist and even purchase an MP3 file of the song or the CD on which it was released.

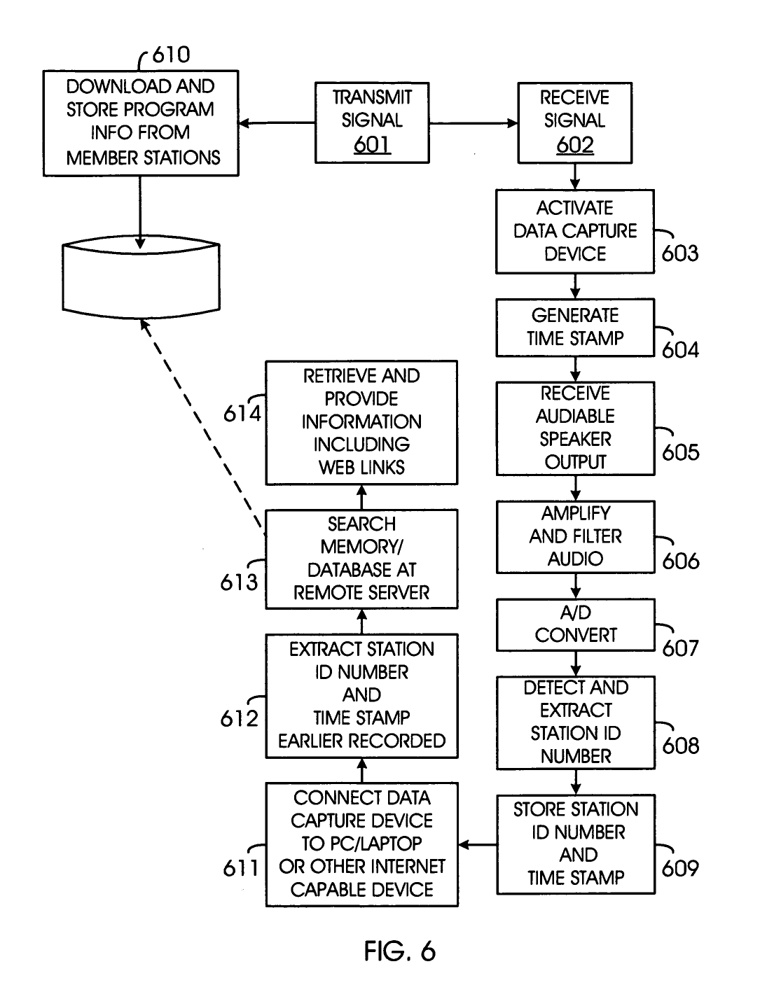

Referring to FIG. 6, there is shown a flow chart which illustrates the process for allowing a user to selectively capture inaudible information embedded in a broadcast signal and use that information in order to later identify broadcast information/content and obtain additional information, including information on where to purchase music heard during the broadcast. As shown, the first step in the process is the transmission of a broadcast signal from a subscribing station, said signal having encoded/embedded therein inaudible information or data including a STATION ID NUMBER 601. In the second step, a user receives the broadcast over his or her portable radio or car radio and continues to listen until a particular song or particular content/information is broadcast in which the user is interested 602. When a particular song or other information is heard during the broadcast, in which the user is interested, he or she will activate the data capture device 603. Once the data capture device is activated, a time stamp is generated 604.

Once the data capture device is activated, a small microphone within the device picks-up the broadcast audio signals as they are reproduced by nearby speakers 605. The audio is amplified and filtered such that all frequencies except the narrow frequency range containing the inaudible encoded messages 606 are filtered out. The filtered portion of the signal is then converted from analog to digital 607 and a data processor is used to actually detect and extract the STATION ID NUMBER embedded within the received audio signal being reproduced by nearby speakers 608. Once the STATION ID NUMBER is detected and extracted, the STATION ID NUMBER and the previously generated time stamp are both stored within the memory of the data capture device 609 for future reference and use, as will be described further hereinafter.

As described earlier herein, each station is preferably configured to embed its STATION ID NUMBER at regular, shortened time intervals into its broadcast signal—e.g. every 30 seconds. Accordingly, in a preferred embodiment, the maximum amount of time that should pass between activating the data capture device and detection/recordation of any STATION ID NUMBER and time stamp should be 30 seconds.

Meanwhile, referring still to the flow chart shown in FIG. 6, as each member station sends out its broadcast signal, programming information identifying the content of each broadcast for each member station is transmitted to and stored in a memory/database at a remote server location 610. It should be noted that this step can occur in real time as the broadcast signal is being transmitted or at any other future point in time at regular intervals, such as on a daily or weekly basis. This programming information preferably includes information sufficient to identify each song title, each song artist and the start and stop time of each programming segment. This programming information is stored in a memory at the remote server location.

At a later point in time, perhaps a day or even a week later, the user will insert the data capture device into a hot sync cradle which, when detected as having been inserted into said hot sync cradle, will enable/direct his or her PC/laptop to the Internet address of the remote server location. In the case where no cradle is used, the data capture device is coupled directly to the user's PC/laptop or other Internet capable device via a communications interface, such as a USB port, and once this connection is established/detected, the user's PC/laptop or other Internet capable device is directed to the Internet address of the remote server location 611.

Once connected with the remote server location, the STATION ID NUMBER and the time stamp which were earlier recorded in memory are then extracted 611 and used to locate the appropriate programming information for that particular station at that particular time which is stored in the memory/database at the remote server location. More specifically, the memory/database at the remote server location is searched for a corresponding match to the STATION ID NUMBER and a particular programming segment or item played/broadcast during the time stamp.

The appropriate programming information is then retrieved from the memory/database at the remote server location. The remote server may already have some information about availability of the item being sought (for example, through a partnership agreement with a retailer offering that item for sale). Alternatively, the remote server may search the Internet for relevant information and present the user with a menu of purchasing/downloading options. A combination of both approaches can also be used; “preferred vendors” would be shown on the top of the list, followed by the results of the Internet search.

As a final matter, and as earlier described, each data capture device is equipped with an internal clock 307 which is preferably synchronized with a universal or master clock and each radio station has its individual programming set to this same master or universal clock. This will ensure that the time stamp generated by any individual data capture device will accurately reflect and match-up with the broadcast information for any member station broadcast at that same time. Accordingly, every time a user connects his or her data capture device to the remote server location, the internal clock on said data capture device will be calibrated in order to ensure accuracy and coordination with the master or universal clock by which all member radio stations set their programming schedule.

While the description above contains many specifics, it should not be construed as a limitation on the scope of the invention, but rather as an illustration of exemplifications of particular embodiments thereof One of ordinary skill in the art may make many changes, modifications, and substitutions without necessarily departing from the spirit and scope of the invention. Accordingly, the scope of the invention should be determined not by the embodiments described above, but by the appended claims and their legal equivalents.

What is claimed is:

1. A data capture device for selectively receiving an audible broadcast signal, extracting inaudible data embedded/encoded within said signal, and recording such data for future use, said device comprising:
a button for selectively activating the data capture device;
a microphone, for receiving/picking-up the broadcast signal as it is reproduced by a nearby speaker once the data capture device has been activated;
a filter designed to filter out all frequencies except a narrow frequency range containing the embedded/encoded data;
an analog to digital converter for converting the filtered signal into a digital signal;
a data processor for receiving the digital signal and detecting and extracting the embedded/encoded data;
a clock for generating a time stamp when the data capture device has been activated;
a memory device for storing the extracted data and the time stamp.

2. The data capture device of claim 1, where in the embedded/encoded data includes a STATION ID NUMBER.

3. The data capture device of claim 1 further comprising:
a USB port for coupling the data capture device to a PC/laptop or other Internet capable device such that the extracted data and time stamped stored in the memory can then be used to retrieve radio station programming information stored at a remote server location.

4. The data capture device of claim 3 wherein the retrieved station programming information corresponds with the time stamp stored in the memory.

5. The data capture device of claim 3 wherein the retrieved station programming information includes an artist name, a song title, and at least one internet IP address from which the song or media containing the song, such as a compact disc, may be purchased.

6. A system for allowing a listener to selectively capture and record information encoded within a radio broadcast signal and later use said information in order to obtain product/retail information related to the broadcast, said system comprising:
a remote server having a memory/database for storing programming information from a member station;
a data capture device for allowing a user to selectively capture and record inaudible information encoded within said radio broadcast;
software for allowing the data capture device and the remote server to actively communicate via the Internet such that the selectively captured and recorded inaudible information can be used to access and retrieve relevant programming information stored at the remote server.

7. The system of claim 6, wherein the programming information stored at the remote server includes a station id number, a song title, an artist name, a start and stop time, and at least one web link address where an album/CD/single/MP3 file of the song may be purchased.

8. The system of claim 6, wherein the programming information stored at the remote server includes a station id number, a product name, an advertiser name, a start and stop time, and at least one web link address where the product being advertised may be purchased.

9. The system of claim 6, wherein the inaudible information which is selectively captured and recorded includes a STATION ID NUMBER which is particular to the radio station from which the broadcast originates.

10. The system of claim 6, wherein the data capture device includes:
a button for selectively activating the data capture device;
a microphone, for receiving/picking-up the radio broadcast as it is reproduced by a nearby speaker once the data capture device has been activated;
a filter designed to filter out all frequencies except a narrow frequency range containing the encoded information;
an analog to digital converter for converting the filtered signal into a digital signal;
a data processor for receiving the digital signal and detecting the station id number;
a clock for generating a time stamp when the data capture device has been activated;
a memory device for storing the station id number and the time stamp.

11. A method for allowing a user to conveniently capture data encoded/embedded within a broadcast signal and later use that information in order to obtain further information relevant to the broadcast, said method comprising:
transmitting a broadcast signal from a subscribing station, said signal having encoded/embedded therein inaudible information or data including a STATION ID NUMBER;
receiving the broadcast signal until a particular song or particular content/information in which a user is interested is broadcast;
activating a data capture device when a particular song or other particular content/information is heard during the broadcast, said data capture device when activated then generating a time stamp, detecting a STATION ID NUMBER embedded/encoded within said broadcast signal , and storing both the STATION ID NUMBER and the previously generated time stamp for future reference and use.

12. The method of claim 11 further comprising:
transmitting and storing programming information identifying the content of each broadcast for each member station in a memory/database at a remote server location, said programming information preferably including information sufficient to identify each song's title, artist and the start and stop time and each advertising announcement's product name, advertiser's name, and the start and stop time;
inserting the data capture device into a hot sync cradle which, when detected as having been inserted into said hot sync cradle, will enable/direct his or her PC/laptop to the Internet address of the remote server location where the programming information is stored;
extracting the STATION ID NUMBER and the time stamp which were earlier recorded in the data capture device and using this information to locate the appropriate programming information for that particular station at that particular time which is stored in the memory/database at the remote server location;
enabling further research and/or purchase of items described by programming information captured.
